(19) United States
(12) Patent Application Publication
(10) Pub. No.: US 2005/0262439 A1
(43) Pub. Date: Nov. 24, 2005

(54) Automatic web publishing

(76) Inventor: Neil Cameron, Cheltenham (GB)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 10/851,772

(22) Filed: May 20, 2004

(51) Int. Cl. G06F 17/21

(52) U.S. Cl. 715/523

(57) ABSTRACT

A system for automatically publishing documents to a website in PDF format is presented. In accordance with some embodiments of the present invention, a document tagged for publishing to a website is, when edited, converted to PDF format and posted to a website in an XML template with little or no user intervention. A method of publication according to the present invention includes attaching a source folder to a document library, attaching a destination web site to a document library, and building a web site for publication at the destination web site from the source folder.

### BACKGROUND

1. Field of the Invention

The present invention is related to web publishing and, in particular, to a method of automatically publishing files created by an application to a web site in a portable document format (PDF) file.

2. Background of the Invention

Organizations from large to small regularly require publication of documents to both internal and external web sites. The documents, and the information contained within these documents, may be produced by specific manufacturer software applications such as, for example, office suites (Microsoft Word, Excel, or other such documents). For reasons of both security and portability it has become the practice of many such organizations to convert documents produced in these software applications into the well-known PDF (Portable Document Format) format before publication on a web site.

It is often the case that the original author of the document to be published is without adequate technical skills or inclination to master the processes and intricacies of PDF conversion and the necessary skills to add the resultant PDF document to an existing web site. Even if this were the case it is also often the case that the original authors do not have sufficient time available to perform these tasks or to repeat the procedure in the event that they alter their information such that it requires republishing.

Numerous systems exist for the conversion of manufacturer specific binary files into PDF format. This class of system can be generically described as printer drivers. However, these printer drivers lack entirely the ability to publish converted material to web sites. Additionally, printer drivers lack any management capabilities over such published documents.

Numerous systems also exist to allow non-technical individuals to publish material to web sites. This class of system can be generically described as a content management system. However, typical content management systems are complex to install and configure and often require external software applications such as databases. Further, content management systems do not address specifically the issue of the conversion, publication and subsequent management of documentation in PDF format.

Additionally, a small class of systems exist that address more closely the issue of document conversion and publishing. However, these systems do not utilize XML to display information and do not include a great breadth of inclusive product features.

Therefore, there is a need for a system that allows easy publishing of documents to a website in PDF format.

### SUMMARY

In accordance with the present invention, a system for automatically publishing documents to a website in PDF format is presented. In accordance with some embodiments of the present invention, a document identified for publishing to a website can be automatically converted to PDF format and published to a website using an XML template with little or no user intervention.

A method of publication according to the present invention includes attaching a source folder to a document library, attaching a destination web site to a document library, and building a web site for publication at the destination web site from the source folder. In some embodiments, building the web site includes converting at least one document from the source folder to a PDF formatted document, creating an XML file that includes the PDF formatted document, and publishing the XML file on a web server corresponding to the destination web site. In some embodiments, once activated a web publishing system according to the present invention converts documents from the source folder, and stores the resulting converted files in a destination folder for eventual publication to the destination web site. An XML templating system can be used to display the published documents.

A web publishing system according to the present invention can include a computer executing software code that sets parameters regarding one or more document libraries and builds a web site based on the document libraries and the parameters, wherein at least one document attached to the document libraries is converted to PDF format and published on the web site. In addition, the software may be stored in memory, on a hard disk driver, or on a portable storage drive.

It is to be understood that both the foregoing general description and the following detailed description are exemplary and explanatory only and are not restrictive of the invention, as claimed. The accompanying drawings, which are incorporated in and constitute a part of this specification, illustrate embodiments of the invention and together with the description, serve to explain the principles of the invention.

### BRIEF DESCRIPTION OF THE DRAWINGS

FIGS. 1A and 1B show conceptual block diagrams of a web publishing system according to some embodiments of the present invention.

FIG. 2A illustrates an embodiment of a web publishing system according to the present invention.

FIG. 2B illustrates a computer system that can execute embodiments of a web publishing system according to the present invention.

FIG. 3 illustrates an embodiment of a parameter setting portion of a web publishing system according to the present invention.

FIG. 4 illustrates an embodiment of a new document library definition procedure according to the present invention.

FIG. 5 illustrates a management dates definition process according to some embodiments of the present invention.

FIG. 6 illustrates a sort type definition process according to some embodiments of the present invention.

FIG. 7 illustrates an attributes setting process according to some embodiments of the present invention.

FIG. 8 illustrates a searching parameters definition process according to some embodiments of the present invention.

FIG. 9 illustrates a templating definition process according to some embodiments of the present invention.

FIG. 10 illustrates a set access parameters definition process according to some embodiments of the present invention.

FIG. 11 illustrates a settings manager according to some embodiments of the present invention.

FIG. 12 illustrates a build parameters definition procedure according to some embodiments of the present invention.

FIG. 13 illustrates a web submittal system according to some embodiments of the present invention.

FIG. 14 illustrates a document search procedure according to some embodiments of the present invention.

FIG. 15 illustrates a build process according to some embodiments of the present invention.

In the figures, elements having the same designation have the same or similar functions.

### DETAILED DESCRIPTION

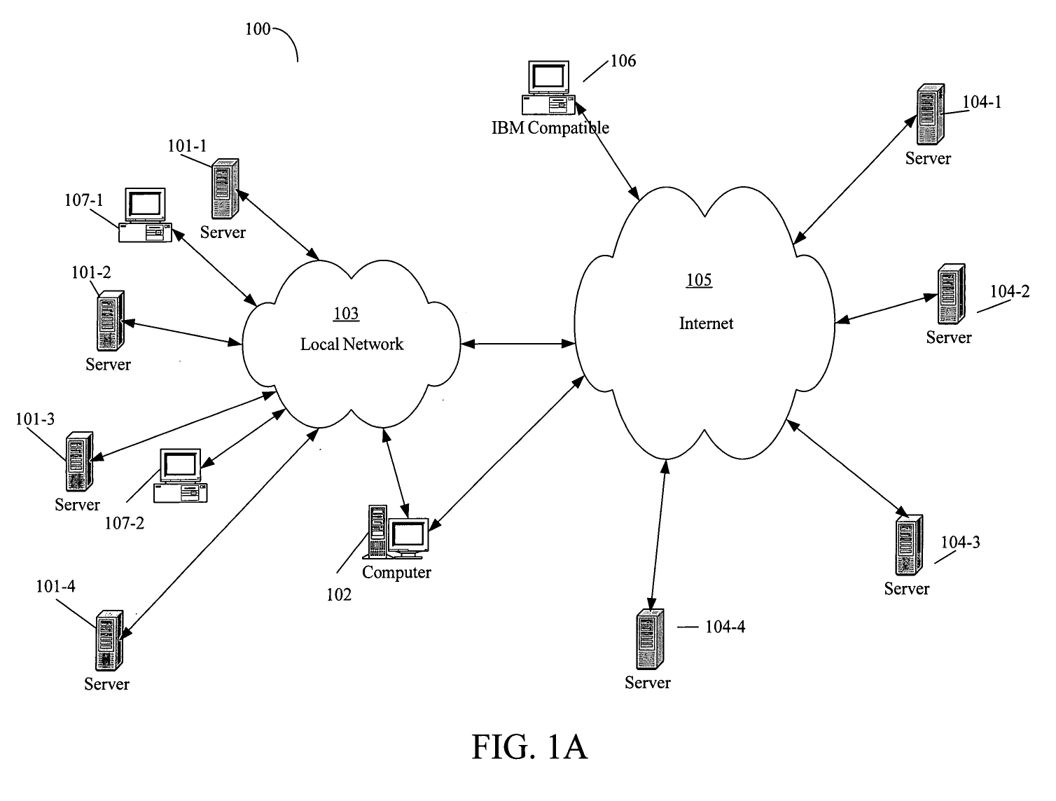

FIGS. 1A and 1B illustrate a web publishing system according to embodiments of the present invention. FIG. 1A illustrates a network environment 100 where a web publishing system according to the present invention can operate. Network environment 100 can include a local network 103 and an internet 105. Local network 103 can be coupled to one or more servers, of which servers 101-1 through 101-4 are shown in FIG. 1A as examples. Servers 101-1 through 101-4 are coupled through local network 103 with user computers, of which computers 107-1, 107-2, and 102 are shown in FIG. 1A.

In some embodiments, one or more of servers 101-1 through 101-4 can host a web site for access from internet 105. A server that can host a web site includes a web server, which is a software application for delivering web content in HyperText Transfer Protocol (HTTP) format. Additionally, internet 105 can be coupled to any number of servers, of which servers 104-1 through 104-4 are shown, at least some of which can also host a web site. Servers 104-1 through 104-4 can also host web sites that are accessible to other users, such as user 106, through internet 105.

Embodiments of the invention can obtain files stored on servers 101-1 through 101-4 and/or computers 107-1, 107-2 and 102. In some embodiments, files stored on servers 104-1 through 104-4 can also be included. Some embodiments of the invention then convert these files to PDF format and publish them on a web site that is hosted by one of servers 104-1 through 104-4 for access by users of the internet or servers 101-1 through 101-4 or for access by users of local network 103 (i.e. intranet) such as users 107-1,107-2 and 102. A build, i.e. the conversion of documents to PDF format and publication to a web site, can in some embodiments occur under the control of an administrator, may occur automatically at pre-determined times, or may occur upon the occurrence of certain events.

FIG. 1B graphically illustrates the operation of some embodiments of web publishing system 150. Web publishing system 150 includes document libraries, of which document libraries 154-1 through 154-5 are shown in FIG. 1B. A document library is defined by a source, such as folder 152 and its contents, and a destination such as web site 156. A folder 152 is an entity defined within a computer to logically link other folders (i.e. sub-folders) and files such as documents. Embodiments of web publishing system 150 can be included in a computer software application and can be executed on, for example, computer 102 shown in FIG. 1A. In some embodiments, web publishing system runs on a Windows operating system. In general, a computer software application that includes embodiments of web posting system 150 according to the present invention can operate with any operating system.

Some embodiments of web publishing system 150 include the ability to identify and apply properties to a collection of documents, which is a binary file produced by a software application such as, for example, Microsoft Word or Excel, for conversion, publication, and subsequent management. In some embodiments, web publishing system 150 can implement document libraries such as document libraries 154-1 through 154-5. In general, a document library can include information regard the location of files, properties of that group of files, attributes, and parameters controlling access and build procedures. Embodiments of web publishing system 150 according to the present invention can provide for the storage, maintenance, and management of any number of document libraries, of which document libraries 154-1 through 154-5 are shown in FIG. 1B.

Some embodiments of web publishing system 150 also include the use of a website templating extensible Markup Language (XML) based system to display documents tagged for publication in document library 154 (an arbitrary one of the document libraries). The displayed documents are posted on web sites coupled to document libraries 154-1 through 154-5, for example. Further, each document library 154 can retrieve files from an attached folder 152 for publication to the attached web site 156 (an arbitrary one of the web sites that are created by web publishing system 150). In FIG. 1B, document library 154-1 through 154-5 is shown as retrieving files from folders 152-1 through 152-5, respectively, for publishing on one of web sites 156-1 or 156-2.

As was discussed above, folders 152-1 through 152-5, which contain documents that are tagged for publication in document libraries 154-1 through 154-5, respectively, can be located on any of servers 101-1 through 101-4 and/or computers 107-1, 107-2 and 102. The particular configuration shown in FIGS. 1A and 1B are for illustrative purposes only and are not intended to be limiting. Embodiments of web publishing system 150 according to the present invention can be implemented on any network.

In accordance with some embodiments of the invention, a set of documents contained within a folder such as one of folders 152-1 through 152-5 is identified (tagged or attached) to a document library such as the corresponding one of document library 154-1 through 154-5. A folder is generally understood within the context of a computer operating system file structure as indexing one or more individual files, where each file can contain a document. The corresponding document library, for example one of document libraries 154-1 through 154-5, controls conversion of the set of documents in the file folder, for example folders 152-1 through 152-5, respectively, into PDF format, publishing the documents in PDF format to a web site, and managing of the contents of the folder. For example, in FIG. 1B, document library 154-1 manages the documents contained in folder 152-1 and converts those documents to PDF format for publication to web site 156-1. Conversion techniques for conversion of documents into PDF format are well known.

In some embodiments, each of document libraries 154-1 through 154-5 includes user-settable properties that will be applied to the documents in the corresponding one of folders 152-1 through 152-5. The user-defined properties of each of document libraries 154-1 through 154-5 affect and control the operation and processing of that document library. In some embodiments, the properties that can be defined by the user include, for example, publication destination, template, schedule, management dates, attributes, and sort type. In general, any number of properties can be defined as properties of a document library, folder, or document. In some embodiments, web publishing system 150 may further allow user defined properties to be inserted.

A publication destination property defines the location on a computer network where the converted documents are to be published. For example, in FIG. 1B the publication destination parameter for document library 154-1 should indicate web site 156-1 while the destination parameter for document libraries 154-2 through 154-5 should indicate web site 156-2.

A template property defines which of a set of XML templates will be utilized to define the web site. Defining the web site includes indicating the navigation, organizational structure, and graphical design of the site where the documents are published. In some embodiments, XML templates can be stored with web publishing system 150 or on a server accessible to web publishing system 150. Further, in some embodiments, XML templates can be user definable and may be created with utilities contained within web publishing system 150. An XML template provides the screen layout and positioning of published documents to a viewer.

A schedule property defines the regularity and timing in which document library re-processes documents from its associated folder. For example, the schedule property of document library 154-1 indicates the times when document library 154-1 re-processes the documents stored within folder 152-1 and publishes the corresponding PDF documents at web site 156-1.

In some embodiments, a management dates property can be included in document library 154. The management dates property for a document library 154 indicates the dates on which documents from the attached folder 152 are published on the attached web sites 156. The management dates property can include rolling and discreet dates. A rolling date defines the period over which the documents indicated by document library 154 are published without being altered. For example if a rolling date of 7 days is set, any document that has not been modified during this period will be removed from the published web site. A discreet date defines a discreet period over which each of the documents indicated by document library 154 is published. Discreet dates are set by defining a date by which the document is published, and another date by which the document is removed. For example, setting a start date of 1 May 2003 and stop date of 31 May 2003 would result in the document being displayed only for the month of May in the year 2003. In some embodiments, the management date property can be set to apply to the entire folder 152 attached to document library 154 or to document library 154 itself, including the publication of the web site template.

Attributes settings allow the addition of meta information pertaining to document library 154, folder 152 indicated by document library 154, or particular documents stored in folder 152, depending on how the attribute is applied. A typical example of an attribute would be an author for a document, or a summary of a document library, folder or document's contents. In some embodiments, attributes can be user defined. Further, attributes can be defined uniquely for a single document library 154 (local attributes) or for all document libraries 154 (global attributes).

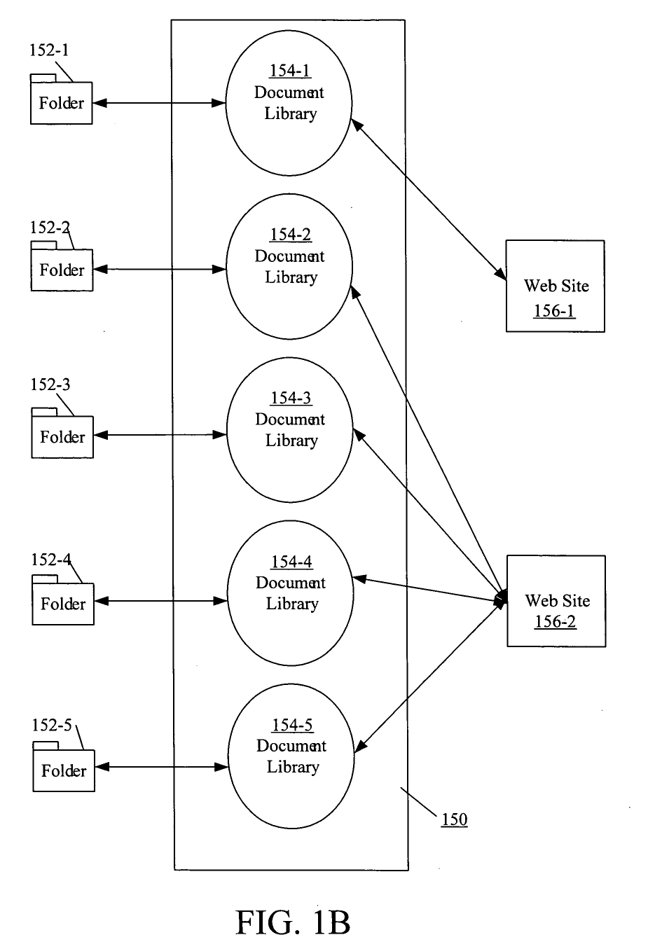

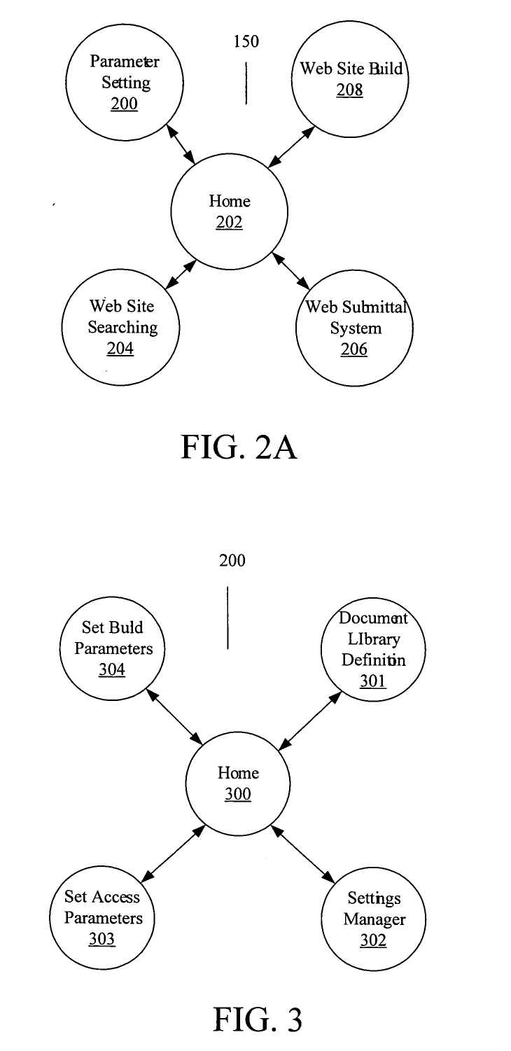

FIG. 2A illustrates an overview of some embodiments of web publishing system 150. As discussed above, web publishing system 150 can be stored and executed, for example, on computer 102 (FIG. 1A). From a home state 202, web publishing system 150 can transition, typically under a user's direction, to parameter setting 200, web site searching 204, web submittal control 206, and web site build 208. In some embodiments, any or all transitions can be initiated from computer 102 or from a user coupled to local area network 103 or internet 105.

In parameter settings 200, document libraries 154 can be defined and parameters associated with document libraries 154 and other aspects of the operation of web publishing system 150 can be set. In web submittal control 206, users accessing web publishing system 150 through local area network 103 or internet 105 can alter parameters associated with document libraries 154 and can add or delete folders 152 or documents and subfolders within folders 152. In web site searching 204, a user accessing web publishing system 150 through computer 102 or through local area network 103 or internet 105 can search documents in folders 152, for example to find documents that are not presented on web site 156. In web site build 208, web publishing system 150 builds, according to the parameter settings of each of document libraries 154. A build can be performed by web site build 208 at the request of the administrator, at definitive times that are set in parameter setting 200, or in some embodiments manually when one or more documents in folders 152 are modified, added, or deleted.

FIG. 2B illustrates an embodiment of computer system 102, on which embodiments of web publishing system 150 can be executed. Computer system 102 can include a processor 218, a memory 220, a display 210, a user input device 212, data storage device 214, and interfaces 216. In some embodiments, components of computer system 102 can be linked through a bus 217. Computer system 102 can, for example, be a PC compatible computer system. Processor 218 can execute code stored in memory 220 or storage device 214. Storage device 214 can include a hard drive and removable storage, for example a disk drive for receiving disk 215. Display 210 may be a standard computer screen. User input 212 may be a keyboard and mouse or other pointing device. Interfaces 216 may allow coupling to local interface 103 and internet 105. Software code for executing web publishing system 150 can be stored in storage 214 or may be accessible through interfaces 216. The software code for web publishing system 150 can, then, be loaded into memory 220 for execution by processor 218.

In some embodiments, a settings manager, designated as set parameters 200 in FIG. 2A, can be included in web publication system 150 that allows an administrator to modify or input parameters associated with the properties of one or more of document libraries 154-1 through 154-5.

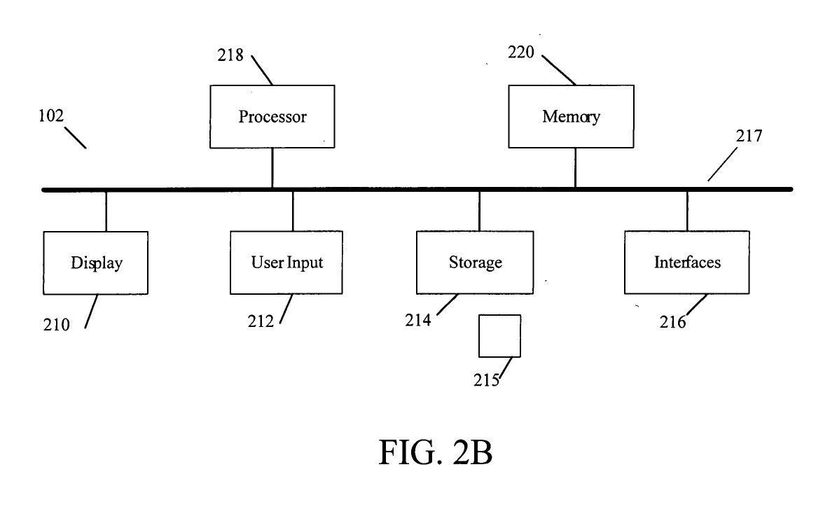

FIG. 3 illustrates an embodiment of Set Parameters 200. In set parameters 200, an operator accessing web publishing system 150 through computer 102 can define document library 154 and can set parameters related to access and operation of web publishing system 150. Once activated, set parameters 200 starts at home 300. From home 300, set parameters 200 can transition to document library definition 301, set general parameters 302, set access parameters 303, and set build parameters 304. In document library definition 301, document libraries 154 can be defined and parameters specific to each document library 154 can be set. In set general parameters 302, global parameters for web publishing system 150 can be set. In set access parameters 303, parameters associated with the access to folders, documents, and parameters afforded to users accessing web publishing system 150 through local area network 103 or internet 105 can be set. In set build parameters 304, parameters associated with the operation of a build can be set.

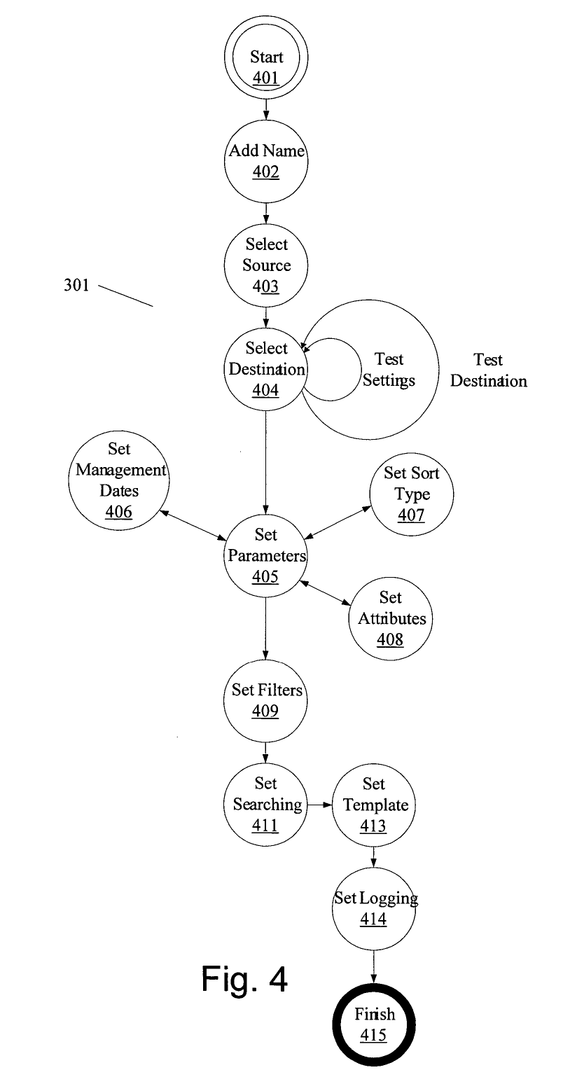

FIG. 4 illustrates an embodiment of document library definition 301 for defining one of document libraries 154. After selecting the add new document library option in web publishing system 150, document library definition 301 begins at start 401, where a new document library 154 is created. A name can be assigned to the new document library 154 in add name step 402. In some embodiments, the name can be assigned by the user defining document library 154. In some embodiments, however, names can be automatically set if the user does not set a name.

In step 403, a source can be selected for document library 154. As was discussed above, the source identifies a folder 152 that contains document files or sub folders that contain document files that are to be published, the folder 152 then becomes attached to document library 154. With reference to FIG. 1A and FIG. 1B, the source folder 152 can be any folder on any server or other storage device that is accessible to web publishing system 150. In some embodiments, document library 154 can be identified with one folder 152. In some embodiments, however, document library 154 can be identified with multiple folders 152. Further, in some embodiments source folders 152 can be assigned to one or multiple document libraries 154. Additionally, there can be any number of individual document files or sub-folders with document files stored in each folder 152.

A destination that is to be attached to document library 154 can then be identified in step 404. The destination can be a web site 156, such as web sites 156-1 or 156-2 shown in FIG. 1B. In addition to defining a destination on which to publish documents indicated by the source attached to document library 154, in some embodiments the transmission of documents between web publishing system 150 and a web site 156 can be tested. Documents can be transferred to web site 156 in any format, for example FTP (File Transfer Protocol) can be utilized. If FTP is to be used as the method of transferring converted files and template files, step 404 can include a test facility to test the FTP settings. Further, the destination web site 156 can be checked for its ability to receive files from web publishing system 150. Once selected destination web site 156 can be checked to ensure no files are already present at web site 156. If there are files present, web publishing system 150 at step 404 can warn the user of their presence and, in some embodiments, that these files will be deleted by web publishing system 150 once a build operation, as discussed herein, begins. In some embodiments, the user can then choose an alternative destination if desired. In addition, a destination folder that stores converted documents prior to publication can be assigned to document library 154.

Once the destination web site 156 is determined in select destination step 404, properties can be determined in set properties step 405. Set properties step 405 controls the progression of properties settings and can transition to set management dates 406, Set attributes 408, and set sort types 407. In some embodiments, other properties may be set from set properties step 405. If no properties are set by the user, then properties can be left at their default values.

From set properties step 405, management dates can be set in set management dates step 406. In set management dates 406, the user can set rolling dates, discreet dates, or no dates. In the case of no dates, the lifetime of documents posted to the determined web site is not determined by web publishing system 150. Setting discreet dates allows the user to indicate that certain folders or documents are to be displayed at particular times. Setting rolling dates allows the user to indicate that folders or documents are to be published for a set period of time after the folder or document has not been amended.

Additionally, from set parameters step 405, sort types can be set in set sort type step 407. In set sort type step 407, the order in which documents are posted are determined. For example, a user can indicate that documents are posted alphabetically in ascending or descending order, documents can be posted by creation date in ascending or descending order, or the user can determine a sorting criteria. Further, from set parameters step 405, attributes can be set in set attributes 408. As discussed above, in some embodiments attributes can be set for each document, for each folder 152, or for the entire document library 154. Attributes can include parameters such as a title, a creator (as in who defined the document library), keywords to describe the key concepts contained within the document library, or a summary summarizing the contents of the document library.

In addition other settings can be configured in set parameters step 405. For example, additional parameters and settings can include an exclude from document library parameter, an include OS security settings parameter, an always build parameter, or a mark as new parameter. The exclusion parameter has the effect of excluding files or folders from being published. In some embodiments, enough documents can be excluded from document library 154 such that document library 154 can become excluded from itself. In such a case document library 154 can become non-buildable. An exclusion setting is more relevant to folders and individual documents within the document library where it is desirable to exclude folders or individual documents from the build.

An include OS security settings parameters determines whether operating system security settings that have been applied to source documents are to be replicated on the converted documents at the destination web site 156. An always build parameter determines whether every document identified in document library 154 is re-processed whenever a build of document library 154 is initiated or whether only those that have been added, amended, or deleted since the last build was processed. When set, the always build parameter results in every document being processed regardless of whether or not a document has been altered since the last build. Setting a mark documents parameter has the effect of marking the document as new for n days, where n is an integer greater than 0. Setting the mark documents parameter can result in documents being marked new on the published web site for up to n days after their initial publication.

Once parameters are set in set parameters step 405, filters can be identified in set filters 409. Filters provide a way of automatically determining which documents to publish and which documents not to publish. Any filter can be utilized. An example of a useful filter is one where documents included on folder 152 with a particular extension are included in the published web site but are not converted into PDF format. In other words, those documents are published to web site 156 in the same format as they are stored in folder 152, without conversion to PDF format. Another example filter is an exclude filter, where files with a particular extension are excluded from the destination web site 156.

From set filters step 409, document library definition procedure 200 can proceed to set searching parameters 411. In some embodiments, the parameters for searching can be the metatags associated with the documents selected, for example, the author, date of last edit, edit history, identity of editor, or other parameters. When setting searching the user can select document attributes from a list. The list contains factory set attributes (such as author, summary) as well as any user defined attributes. During build, HTML pages can be produce for each PDF document that will contain the attribute name and values as HTML meta tags. As such, the HTML pages associated with each of the PDF documents are readily searchable by any standard web searching system.

From set searching step 411, document library definition procedure 200 may proceed to set template step 413. In set template step 413, a user can select or, in some embodiments, design a web page template to utilize in publishing the documents in files 152 now associated with document library 154. The template can be chosen from a set of templates that are stored in a location accessible to web publication system 150 or can be designed and input by a user.

From set template step 413, document library definition procedure 301 may proceed to set logging step 414. Conversion activity and errors during the build process are logged separately in the build and error logs respectively. In some embodiments in set logging step 414 the user is able to identify the location and disposition of the build and error logs. For example, in some cases all build events and errors may be stored. In others, the build and error logs may store only a limited number of previous events.

From set logging 414, document library definition procedure 301 proceeds to finish 415. In finish 415, any parameters that have not already been stored for future use are stored and document library definition procedure 301 returns to home state 300 (FIG. 3).

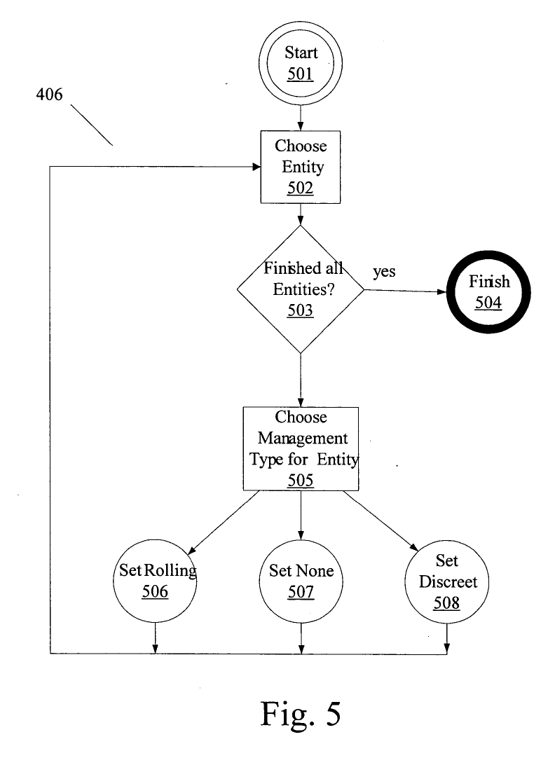

FIG. 5 shows an embodiment of set management dates 406. Set management dates 406 is initiated at start step 501. From start step 501, set management dates 406 proceeds to choose entity step 502. In general, set management dates 406 can be applied to a document library 154, a folder 152, individual sub folders, or to individual documents within the folders or sub-folders. When applied to either a document library 154 or folder 152, sub folders or documents attached to document library 154 will inherit those settings. In set management dates 406, sub-folders and documents can have different management date settings applied. In some embodiments, where a logical conflict occurs, the higher-level settings (parent) will apply. For example if a rolling date of 7 days is applied to a document library 154, but a rolling date of 14 days is applied to a sub-folder attached to that document library 154, then set management dates 406 can apply a rolling date of 7 days to the sub-folder as well. In some embodiments, when setting a date management in a way inconsistent with date managements that have already been set, an error message may be generated and the user asked to correct the inconsistency. If all entities for which date management is to be set have been completed, set management dates 406 is directed by step 503 to finish 504. At finish step 504, set management dates 406 can return to set parameters step 405 as shown in FIG. 2.

Once an entity has been chosen (i.e., the document library, folder, or document) in step 502, set management dates 406 proceeds to choose a management type in step 505. In the example shown in FIG. 3, the management types that are available include rolling dates, discreet dates, or no management. In some embodiments, if set management dates 406 is not executed, then the document library, folder, or document are published indefinitely. In some embodiments, other types of date management may be set as well. For example, in some embodiments conditional document presentation depending on other occurrences may be set.

In the embodiment shown in FIG. 5, from step 505, set management dates 406 can proceed to either set rolling dates 506, set none 507, or set discreet dates 508. Setting a rolling date in step 506 includes setting the period of time that documents are published. The rolling date can be defined in days, but in some embodiments may also be set in any time unit (e.g., months or years). Setting a discreet management date in step 508 includes defining a date and time on which the document library, folder, or document is to be published, and a subsequent date and time where that same document library, folder or document is to be removed from the published web site. When no management dates are applied, as in step 307, then the document library, folder, or document are published for an indefinite period.

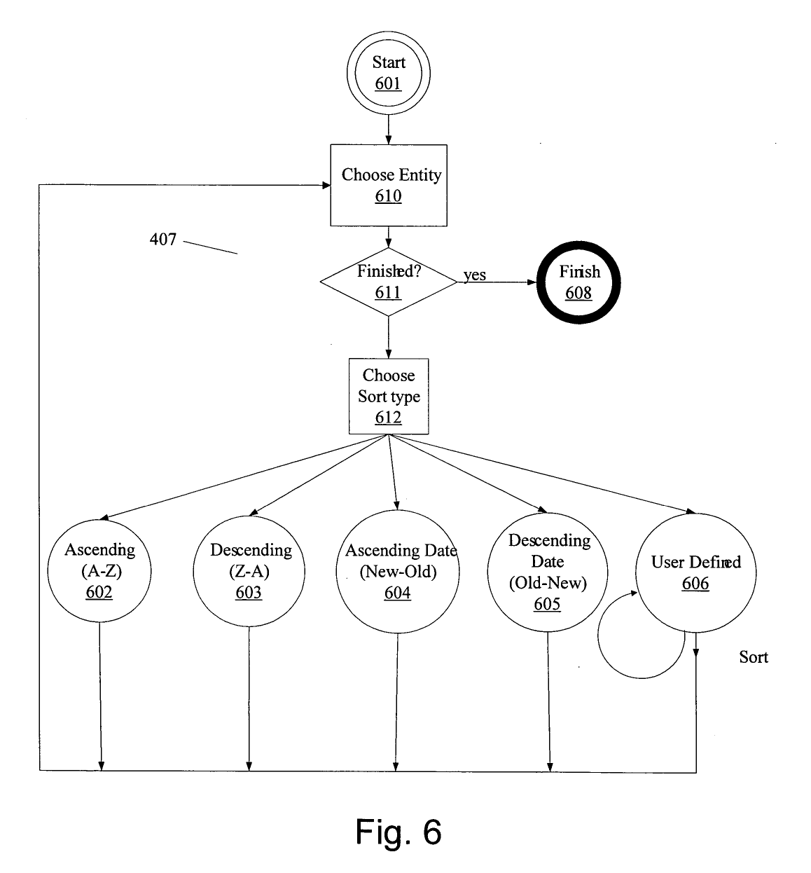

FIG. 6 shows an embodiment of set sort type 407. Sort types control the order in which folders and documents are presented in destination web site 156. Sort types can be applied to document libraries and folders. Document libraries, folders and sub folders can have different sort types applied. In general, when presented documents will be sorted first by the sort type of the document library, then the folder, then subfolders.

As shown in the embodiment of FIG. 6, set sort type 407 is initiated at start 601. From start 601, an entity (e.g., document libraries or folders) for which a sort type is set is chosen in step 610. In step 611, if all of the sort types for all of the entities have been set, then set sort type 507 finishes at finish 608 and returns to set parameters 405. Otherwise, set sort type 407 proceeds to step 612 where a sort type is chosen. In the embodiment shown in FIG. 6, the sort types that can be chosen include ascending (A-Z), descending (Z-A), ascending date (new-old), descending date (old-new), or a user defined sort. In some embodiments, other sort types can be utilized. In some embodiments, default values can be set such that documents are presented in ascending alphabetical order.

If ascending (A-Z) is chosen, set sort type 407 proceeds to step 602. In the ascending sort type, folders and documents are displayed alphabetically with folders and documents with names beginning with A being listed first, and those with names beginning with Z being listed last. If descending (A-Z) is chosen, then set sort type 407 proceeds to descending (Z-A) 603. In the descending sort type, folders and documents are displayed alphabetically with folders and documents with names beginning with Z being listed first, and those with names beginning with A being listed last. If the ascending date (new-old) sort type is chosen for that entity, then set sort types proceeds to step 604. In the ascending date (new-old) sort type, folders and documents are displayed in terms of the date on which they were last modified with folders and documents most recently modified being listed first. If the descending date (old-new) sort type is chosen, then set sort type 407 proceeds to step 605. In the descending date (old-new) sort type, folders and documents are displayed in terms of the date on which they were last modified with folders and documents most recently modified being listed last. If a user defined sort type is chosen, then set sort type 407 proceeds to step 606. In the user defined sort type, the user can sort the order in which documents and folders are listed. This option can allow the user to define sorts that are not defined by other sort types. In some embodiments, a user defined sort type is tested for consistency by sorting the indicated entity.

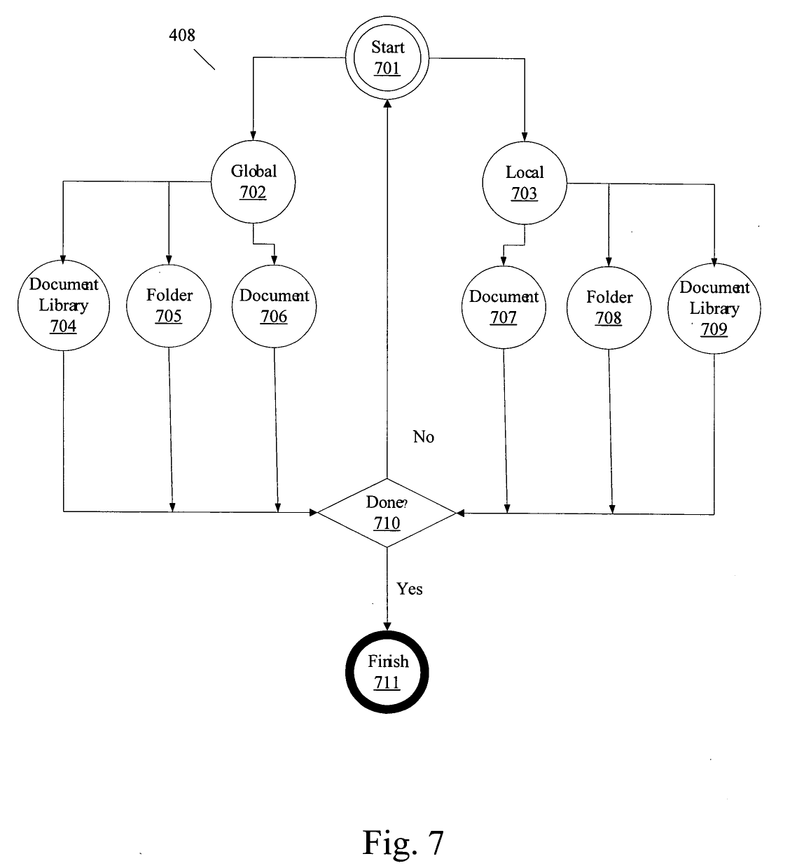

FIG. 7 shows an embodiment of set attributes 408. Set attributes 408 is utilized to set particular attributes for all document libraries, for individual document libraries, for individual folders, or for individual files. Examples of attributes include project titles, project sub-system, project code, The system allows for the concept of user definable attributes, which allow users to define any attributes they may feel pertinent to either a document, folder or document library. An example might be a “Project Title” which can be defined for a document library that deals with only one project. A “Project Sub-System” attribute can be defined for folders within that document library where each folder contains documents pertaining to a particular sub-system of the project. A “Project Code” attribute can be defined for all documents within that project. When defining an attribute a “Type” is defined, this is the name of the attribute. The type for the attribute containing a summary would be “Summary”. Attribute values, i.e. the text for the summary, the project code, the authors name etc, are entered separately. Attributes when added are also incorporated automatically into the extensible mark-up language (XML) templating system of web site 156. XML is a computer language that is used for the storage of data in the presentation of web sites.

As shown in FIG. 7, set attributes begins at start step 701. If the attribute is a global attribute, set attributes 408 proceeds to global 702. From global 702, if the attribute to be set applies to document libraries, then set attributes 408 proceeds to document library block 704 where that attribute is set. If the attribute to be set in global 702 applies to folders, then set attributes 408 proceeds to folder attributes 705. If the attributes to be set in global 702 refer to documents, then set attributes 408 proceeds to document attributes 706.

Alternatively, if the attribute is to be defined specific to a particular document library, folder, or document, then from start 701 set attributes 408 proceeds to local 703. From local 703, if the attribute to be set is directed towards a document then set attributes proceeds to document block 707 to set that attribute. If the attribute to be set pertains to a folder then set attributes 408 proceeds to folder block 708 to set that attribute. If the attribute to be set pertains to a document library, then set attributes 408 proceeds to document library 709 to set that attribute.

Once the attribute has been set, then set attributes 408 proceeds to test block 710 in order to determine if all of the attributes that are to be set are set. If not, then set attributes 408 returns to start 701 in order to set the next attribute. If all attributes have been set, then set attributes 408 proceeds to finish 711 where document library definition 301 returns to set parameters 405.

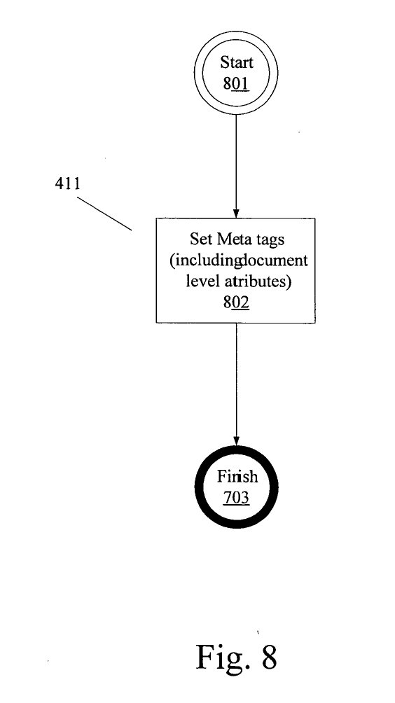

FIG. 8 shows an embodiment of set searching 411. Set searching 411 starts at start block 801, where searching is enabled. When enabled, set searching 411 proceeds to set meta tags 802. In set meta tags 802, parameters are set such that the Hyper Text Markup Language (HTML) page created on web site 156 during a build for each PDF file contains the indicated meta tags, e.g. author, dates of edit, or other document related data. HTML is computer language utilized to present text in a web site. Once that information is included in the web site, it can be searched and located by a web browser. The purpose of this being that any standard search engine that can read standard HTML meta information can search the web site for this meta data. Once meta tags are set in step 802, then set searching 411 finishes at step 803 and returns to document library setup 301.

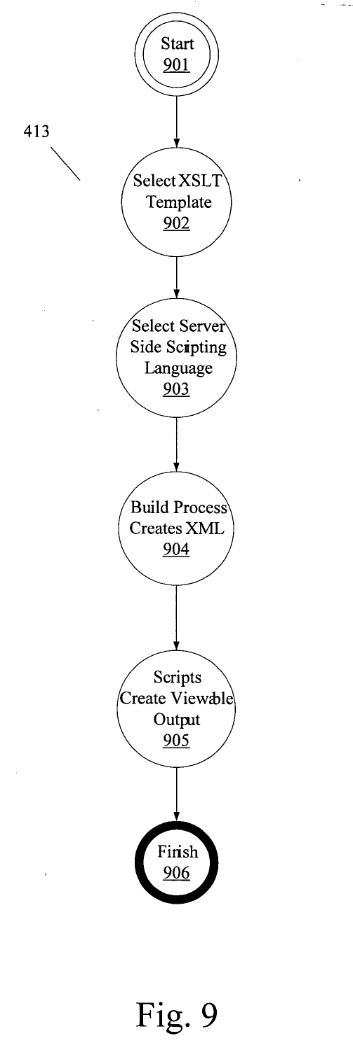

FIG. 9 shows an embodiment of set template 413. These templates control the appearance of web site 156 once it is built. As shown in FIG. 9, set template 413 is initiated at start 901 and then proceeds to select Extensible Style Sheet Language Transformation (XSLT) template 902. XSLT is a computer language used to transform data sets contained in XML files. Templates are built using the XML transformation language XSLT (Extensible Stylesheet Language Transformations). In step 902, the template to use as web site 156 can be chosen from a library of templates or may be chosen from a set of user defined templates. In step 903, the scripting language to utilize on the server is chosen. In some embodiments, the set of server languages can include asp, php, orjsp. The viewable web site is created by having the XSLT templates format data held in XML documents produced in step 904. The transformation is undertaken by a server side scripting language in step 905. Once the user is satisfied with the web site template, then Set Template 413 exits at finish 906 and returns to document library definition 301.

Returning to FIG. 3, once document library definition 301 has completed, parameter setting 200 returns to home 300. From home 300, parameter setting 200 can transition to set general parameters 302. In set general parameters 302, many of the same parameters that were set in document library definition 301 can be set or modified. Additionally, global parameters that apply to all document libraries 154 can be set. Additionally, from home 300, parameter setting 200 can transition to set access parameters 303. In set access parameters 303, parameters controlling the access to folders, documents, and parameters by web submittal system 206 are set. In general, these parameters are not accessible through web submittal system 206. In some embodiments, however, access to these parameters can be obtained through web submittal system 206 with appropriate access codes. Additionally, from home 300, set build parameters 304 can be initiated. In set build parameters 304, parameters controlling the build of web sites are set. These parameters can include periods between builds or conditions for build. In some embodiments, a build of a web site can be initiated if a document or folder attached to document library 154 has been edited or otherwise modified.

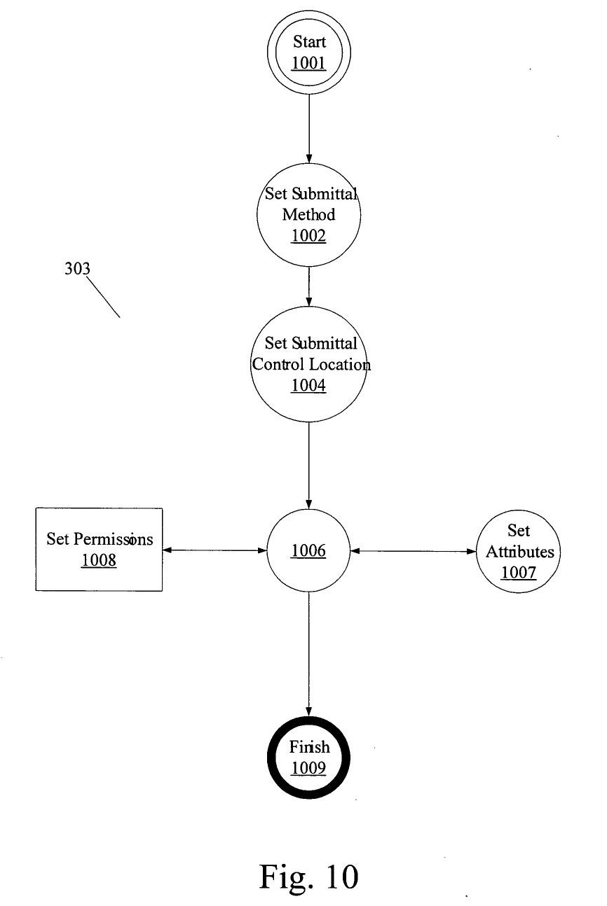

FIG. 10 shows an embodiment of set access parameters 303 directed toward web submittal system 206. As shown in FIG. 3, set access parameters 303 is entered from home 300 and starts at start 1001. The purpose of web submittal system 206 is to allow users to manipulate document library 154 source folders from outside computer 102, for example from a web browser through internet 105 or local network 103. When configuring web submittal system 206 for access to a particular document library 154 (each document library 154 can have its own web submittal system 206 accesses) the first decision is how web submittal system 206 will communicate with the source (i.e. folder 152, subfolders, and documents) that are attached to document library 156. In some embodiments, options can include communication via a network path or via FTP (File Transfer Protocol). This choice can be made in step 1002.

In general, use of web submittal system 206 will be accessible via a browser-based button visible to all people viewing the published web site 156. For those instances where this is not desirable, in step 1002 web submittal system 206 can be published to an alternative location on the computer network. Access to web submittal system 206 from the alternative location set in set submittal control location 1004, then, can be restricted to only those viewers with access to that alternative location. In some embodiments, use of web submittal system 206 from attached web site 156 can be controlled by, for example, setting passwords for access in set submittal control location 1004.

In some embodiments, the number of different types of operation that a user can perform via web submittal system 206 can be definable and can be set in step 1008, which is accessible from step 1006. Options include whether to allow the creation of folders, the deletion of folders, the deletion of documents, the manipulation of attributes or sort order of documents and folders. Web submittal system 206 can be used as a method of collecting attribute values for selected attribute types. When configuring web submittal system 206 with regard to attributes, the attribute types requiring information can be selected in set attributes step 1007. In some embodiments, where appropriate, set access parameters 303 can be made compulsory to fill in a value for a given attribute type. For example users can be forced to enter a summary of a document when submitting a document, or forced to enter a project code when creating a folder.

Additionally, as shown in FIG. 3, parameter setting 200 can transition to set general parameters 302 from home 300. Set general parameters 302 can be invoked to edit parameters that have previously been set in document library definition 301. Further, parameters that apply to a document, folder, document library, or group of document libraries can be set.

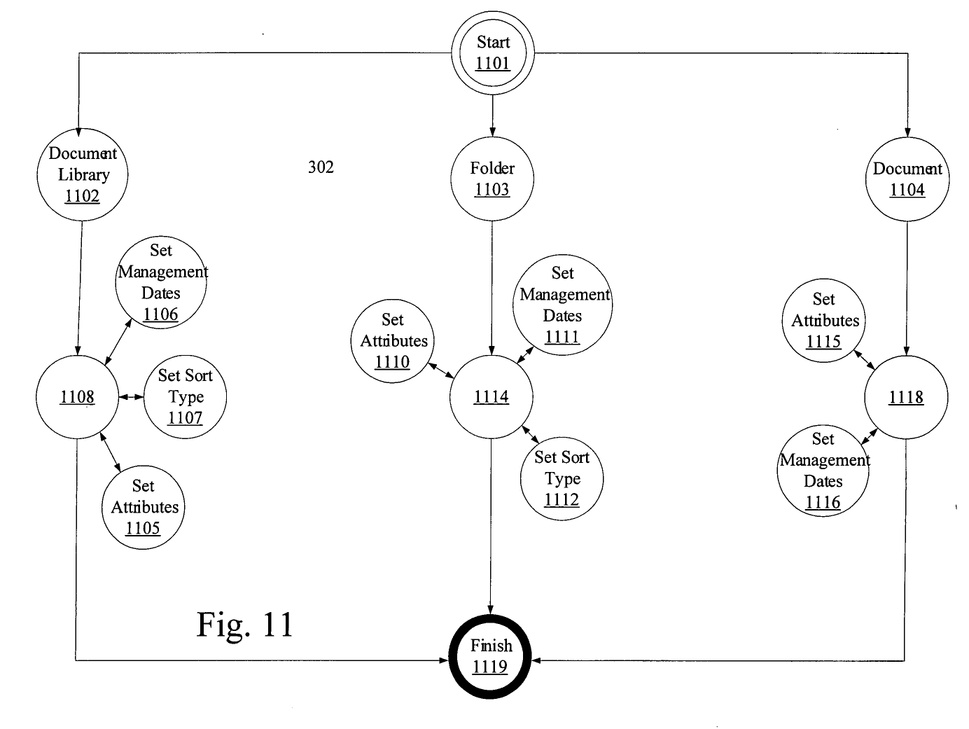

FIG. 11 shows an embodiment of settings manager 302. Additionally, the embodiment of set general parameters 302 shown in FIG. 11 can be invoked by web submittal system 206, provided accesses have been provided allowing the altering of parameters through web submittal system 206 have been provided.

Settings manager 302 is initiated at start 1101 from home 300. As discussed above, in some embodiments settings manager 302 can also be initiated from web submittal system 206. First, it is determined which setting is to be changed. If the setting pertains to a document library, then settings manager 302 proceeds to document library 1102. If the setting pertains to a folder, then settings manager 302 proceeds to folder 1103. If the settings pertain to a document, then settings manager 302 proceeds to document 1104.

From document library block 1102, where the particular document library that settings are to be altered is identified, settings manager 302 proceeds to set parameters 1108. From set parameters 1108, settings manager 302 can proceed to set attributes 1105, set management dates 1106, or set sort type 1107. As was previously discussed, set attributes 1105, which can be similar to set attributes 408, an example of which is shown in FIG. 7, can set attributes regarding the selected document library can be set. Such attributes can include, for example, the operating security settings, build settings (e.g., always build or build only on document revisions), or mark as new settings. In set management dates 1106, which can be similar to set management dates 406 shown in FIG. 5, data management parameters for the chosen document library are set. For example, rolling or discrete dates for presentation of the documents attached to that document library can be set. In sort type 1107, which can be similar to sort type 407 shown in FIG. 6, the sort type to be used for document library (e.g., ascending, descending, ascending date, descending date, or user defined) can be set.

Similarly, from folder settings 1103, after a particular folder is identified, settings manager 302 can proceed to set parameters 1114. From set parameters 1114, settings manager 302 can proceed to set attributes 1110, set management dates 1111, and set sort type 1112. In set attributes 1110, attributes associated with a folder, for example inclusion parameters, operating security parameters, and build parameters, can be set. In set management dates 1111, management date parameters can be set for that folder. In set sort type 1112, the sort type for that folder can be set.

Additionally, for document setting 1104, once a particular document is identified, settings manager 302 can proceed to set parameters 1118. From set parameters 1118, settings manager 302 can proceed to set attributes 1115 or set management dates 1116. In set attributes 1115, attributes pertaining to the particular document can be chosen. In set management dates 1116, the management dates parameters for that document can be set.

Once the parameters have been set, settings manager 302 can proceed to finish 1119 where a return to home 300 (or web submittal control 206) can be performed. It is through settings manager 302 that management dates, attribute values, sort types and other settings such as exclude from document library, include operating system security settings, or always build, for example, can be applied or edited for a document library, folder, or document. In addition to the above settings, the PDF security model, which allows a PDF file to be secured, can also be accessed through the settings manager for individual documents.

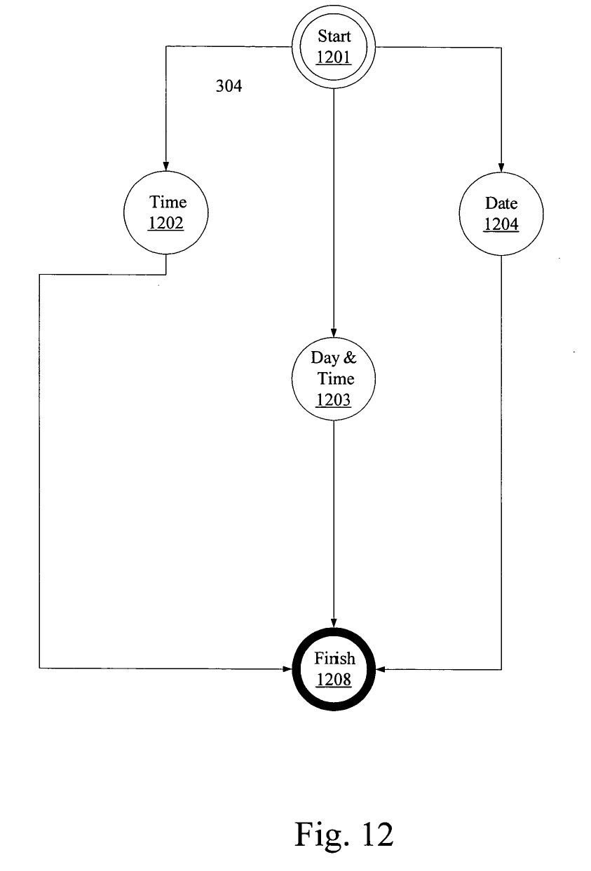

FIG. 12 shows an embodiment of set build parameters 304. In particular, the embodiment of set build parameter 304 shown in FIG. 12 includes a scheduler, which sets the timing parameters for the build procedure. FIG. 12 shows the scheduler embodiment of set build parameters 304. Set build parameters 304 can be used to control the timing and regularity of the build process. Each document library 154 can have its own schedule, entirely separate from the schedules of all other document libraries. Schedules can be defined in three ways: time, day & time, and date. In FIG. 12, set build parameters 304 can transition from start 1201 to time 1202, day & time 1203, and date 1204. In time 1202, parameters are such that a build process will run every n hours, where n is an integer. In date & time 1203, parameters are set such that a build process will occur on a selected day at a selected time, for example every Sunday at 10:00 am. In date 1204, parameters are set such that a build process occurs once on a given date. In some embodiments, other build parameters can be set. For example, a build may be initiated upon a trigger event such as the modification of a document or folder attached to the document library or a document library can be built upon manual trigger.

Some embodiments of web publication system 150 can include a web submittal system 206 in order that a document library's source folder's contents can be manipulated through access from a web browser.

The number of different types of operations that a user can perform via web submittal system 206 can, in some embodiments, be definable. Options include whether to allow the creation of folders, the deletion of folders, the deletion of documents, the manipulation of attributes or sort order of documents and folders within the system. In general, web submittal system 206 will be accessible via a browser-based access (i.e. through internet 105) that can be visible to all people viewing the published web site, e.g. web sites 156-1 and 156-2). For those instances where public access is not desirable, web submittal system 206 can be published to an alternative location on the computer network where access can be restricted to only those viewers with access to that alternative location.

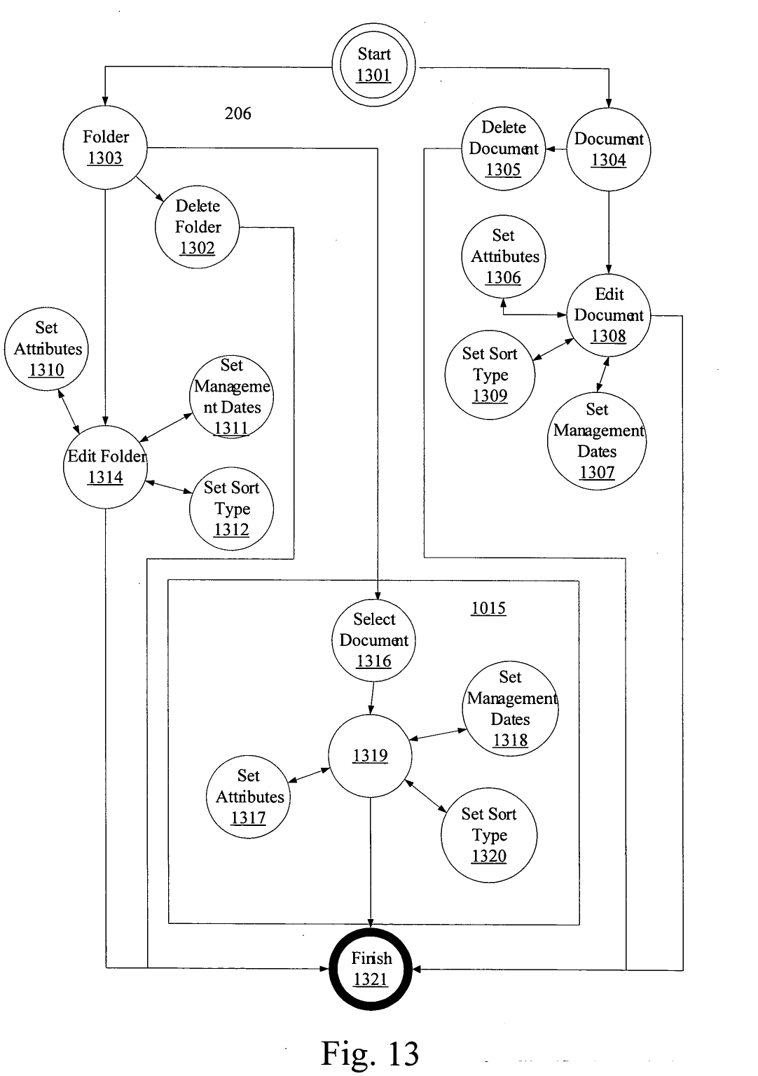

FIG. 13 shows an embodiment of web submittal system 206. Web submittal system 206 begins when activated at start 1301. Again, web submittal system 206 can be initiated from web site 156 or may be initiated from a different, limited-access web site. Additionally, the breath of activities that are allowed to be performed through web submittal system 206 is determined by the parameter settings that can be set in set access parameters 303, as illustrated in FIG. 10. In the embodiment shown in FIG. 13, depending on the security settings the user can either perform actions on a folder or document. If the user chooses to act on a folder, web submittal system 206 transitions to folder 1303. Alternatively, if the user chooses to act on a document, then web submittal system 206 transitions to document 1304.

From folder 1303, web submittal system 206 can transition to delete folder 1302, to edit folder 1314, or to add document 1315. In delete folder 1302, a folder can be deleted provided that the privilege to delete folders through web submittal system 206 has been granted. In edit folder 1314, properties of the folder can be edited. From edit folder 1314, web submittal system 206 can transition to set attributes 1010, set management dates 1311, or set sort types 1312. In add document 1315, a document is added to the folder. The document is first selected in select document 1316, then settings are applied to that document in block 1319. In some embodiments, the properties that can be set from set documents 1319 include attributes in set attributes 1317, management dates in set management dates 1318, and sort types in set sort types 1320.

From document 1304, web submittal system 206 can transition to delete document 1305 or edit document 1308. In delete document 1305, a document can be deleted if that privilege has been granted to web submittal 206. From edit document 1308, the properties of the document can be edited. As is shown in FIG. 13, the attributes of the document can be edited in set attributes 1306, the management dates can be edited in set management dates 1307, and the sort type can be edited in set sort types 1320.

In some embodiments, web publication system 150 includes web site searching 204 (FIG. 2A), which can include tools so that a user can set utilities and locate documents that have had management dates applied to them and may therefore have been removed from the published web site, or possibly have not yet been published. In some embodiments, web site searching 204 capability provides a simple mechanism by which attribute information can be searchable by a wide variety of searching utility software products produced by other parties.

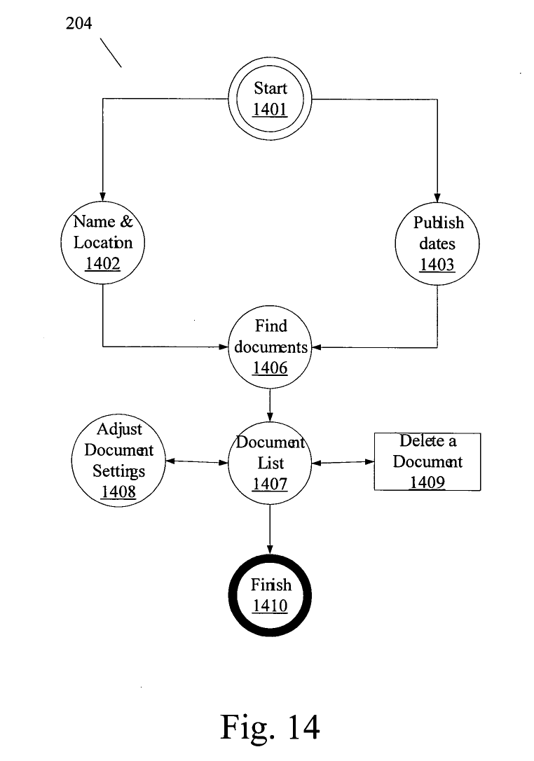

FIG. 14 shows an embodiment of web site searching 204 In some embodiments, the purpose of web site searching 204 is to help locate documents within a document library source. Documents can be located by any of the attributes of the document, including name or title, author, date of creation, last edit dates, location publish dates, or any other attribute. In some embodiments, web site searching 204 can be utilized to locate documents that are excluded from publication. Web site searching 204 starts at start 1401 and proceeds to name and location 1402 if a search on name or location is to take place or to publish dates 1403 if a search on publication dates is to take place. From search parameter setups such as name and location 1402 or publish dates 1403, web site searching 204 proceeds to find documents 1406 where the sources (i.e., folders 152, subfolders and documents) are searched for documents that match the search criteria. In document list 1407, a list of documents that match the search criteria is created and displayed. The user then can perform actions on the listed documents, such as delete documents in step 1409 or initiated set parameters 302 in adjust document settings 1408.

The process of converting and publishing documents is referred to as a build. Once defined, and properties are set, then document libraries 154-1 through 154-5 can be built. Some embodiments of the invention provide the ability to build document libraries 154-1 through 154-5 individually or to build all or some of document libraries 154-1 through 154-5 at a time. Further, some embodiments provide the capability to perform a full build (where all documents are re-processed regardless of whether or not they have changed since the last build) or an incremental build (where only those documents that have changed since the last build are processed). Some embodiments of the invention also provides the option that the build can be performed on a scheduled basis.

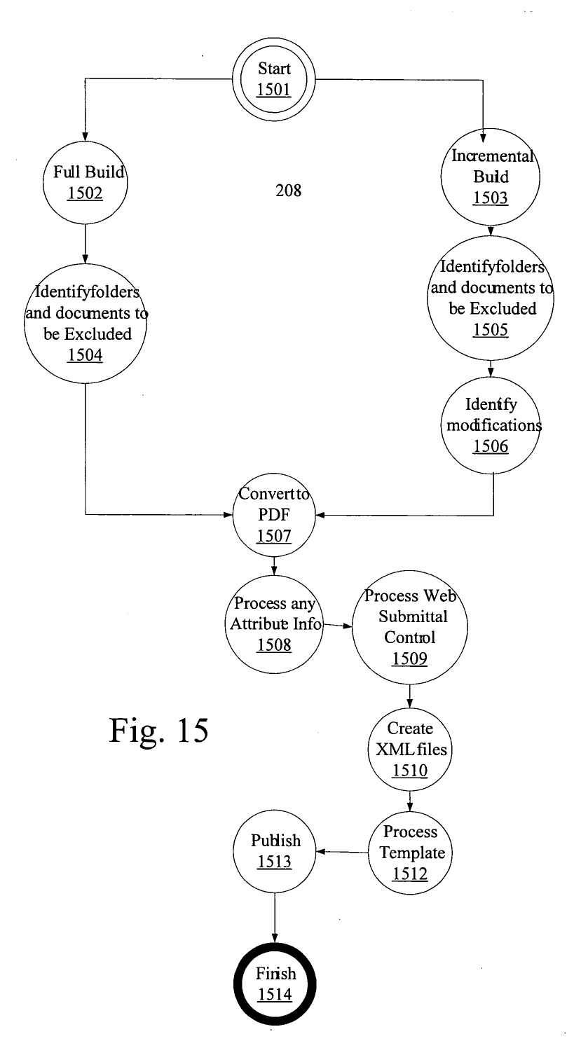

FIG. 15 shows an embodiment of web site build 208 (the build process). Initially a decision is made as to whether to perform a full build or an incremental build. In some embodiments, if web site build 208 is automatically run, the decision can be made by reading parameters that were previously set in set build parameters 304. If it is the first time a document library has been built it is always considered a full build regardless of instructions or parameters. From start 1501, then, web site build 208 proceeds to full build 1502 or incremental build 1503, depending on whether a full build or incremental build, respectively, will be performed.

From full build 1502, web site build 208 proceeds to step 1504 where documents, folders or even entire document libraries that have been excluded from the build for whatever reason are identified. The parameter that indicates an excluded entity is set in set parameters 200 and can be set in either document library definition 301 or settings manager 302. Other possible reasons for excluding documents include whether the entity has a management date set that excludes the date of the current build. Further, the particular document may have a document extension that has been marked for exclusion.

From incremental build 1503, web site building 208 proceeds to step 1505 where documents, folders, or document libraries that are to be excluded from the build are identified. Step 1505 and step 1504 can operate in the same fashion. From step 1505, web site building 208 proceeds to identify modifications 1506. Modifications include identification of new or modified documents, new folders, deleted documents or folders, amended security settings on documents or folders at either an operating security system level or PDF document security level, or attribute information changes in the document, folder or document library. In some embodiments, a comparison of the documents and folders with the currently published documents and folders is performed to identify modified documents and folders. In some embodiments, documents and folders can be marked as modified by setting a flag when the document or folder is actually modified.

From step 1504 and step 1506, web site building 208 proceeds to PDF conversion 1507. In PDF conversion 1507, all documents that are to be published, except for those that are excluded from conversion, are converted to PDF format. Algorithms for converting documents into PDF format are well known. In step 1508, attribute information associated with the documents or folders is then processed. This process is applied to all folders and documents within the document library source and includes document types that have been identified to be published but not converted. If the web submittal system 206 has been configured for use, then access parameters and access controls appropriate to this build is considered in step 1509. XML files are then created for the document library and each folder within the document library source in steps 1510 and 1512, using the templates that have been predefined for the build. These XML files contain attribute information and sort orders for the documents and folders within them. The resulting files are then published in step 1513 either via FTP (File Transfer Protocol) or a path. In some embodiments, error detection and activity logging can be undertaken, and if configured to do so by setting of the logging parameters, written to the appropriate log files.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

1. A method of publishing documents, comprising:
attaching a source folder to a document library;
attaching a destination web site location to a document library; and
building a web site for publication at the destination web site in accordance with the document library.

2. The method of claim 1, wherein building the web site comprises
converting at least one document from the source folder to a PDF formatted document;
creating an XML file that includes the PDF formatted document; and
publishing the XML file on a web server corresponding to the destination web site.

3. The method of claim 1, further including setting properties associated with the document library.

4. The method of claim 3, wherein the properties includes management dates.

5. The method of claim 4, wherein the management dates are chosen from a set consisting of rolling, none, or discreet.

6. The method of claim 3, wherein the properties includes sort types.

7. The method of claim 6, wherein the sort types are chosen from a set consisting of ascending, descending, ascending date, descending date, or user defined.

8. The method of claim 3, wherein the properties includes attributes.

9. The method of claim 8, wherein attributes can be global or local.

10. The method of claim 8, wherein the attributes can apply to a document library, a folder, or a document.

11. The method of claim 1, further including setting filters.

12. The method of claim 1, further including setting searching properties.

13. The method of claim 12, wherein the searching properties include metatags.

14. The method of claim 1, further including setting an XML template.

15. The method of claim 14, wherein setting an XML template comprises:
selecting a XSLT template; and
selecting a server side scripting language.

16. The method of claim 1, further including setting logging.

17. The method of claim 1, further including setting access parameters.

18. The method of claim 17, wherein setting access parameters comprises:
including setting submittal methods;
setting submittal control location;
setting permissions; and
setting attributes.

19. The method of claim 18, further including adjusting properties with a settings manager.

20. The method of claim 19, wherein adjusting properties includes
determining if the property is directed to a document library, a folder, or a document; and
setting properties, wherein the properties includes management dates, attributes, and sort types.

21. The method of claim 1, further including setting build parameters.

22. The method of claim 21, wherein setting the build parameters includes determining at what time a build is performed.

23. The method of claim 1, further including accessing with a web submittal system.

24. The method of claim 23, wherein the web submittal system can edit properties of a folder, a document, or a document library.

25. The method of claim 23, wherein the web submittal system can delete a folder.

26. The method of claim 23, wherein the web submittal system can add or delete a document.

27. The method of claim 1, further including searching with a web site searching.

28. The method of claim 27, wherein the web site searching can locate a document based on search parameters.

29. The method of claim 28, wherein the search parameters include publish dates and name.

30. The method of claim 28, wherein found documents can have properties edited or be deleted.

31. A web publishing system, comprising a computer executing programming instructions for
attaching a source folder to a document Library;
attaching a destination web site location to a document library; and
building a web site for publication at the destination web site in accordance with the document library.

32. The system of claim 31, wherein the programming instructions for building the web site comprises programming instructions for
converting at least one document from the source folder to a PDF formatted document;
creating an XML file that includes the PDF formatted document; and
publishing the XML file on a web server corresponding to the destination web site.

33. The system of claim 31, wherein the program instructions further includes program instructions for setting properties associated with the document library.

34. The system of claim 33, wherein the properties includes management dates.

35. The system of claim 34, wherein the management dates are chosen from a set consisting of rolling, none, or discreet.

36. The system of claim 33, wherein the properties includes sort types.

37. The system of claim 36, wherein the sort types are chosen from a set consisting of ascending, descending, ascending date, descending date, or user defined.

38. The system of claim 33, wherein the properties includes attributes.

39. The system of claim 38, wherein attributes can be global or local.

40. The system of claim 38, wherein the attributes can apply to a document library, a folder, or a document.

41. The system of claim 31, wherein the program instructions further include instructions for setting filters.

42. The system of claim 31, wherein the program instructions further include instructions for setting searching properties.

43. The system of claim 42, wherein the searching properties include metatags.

44. The system of claim 31, wherein the program instructions further include instructions for setting an XML template.

45. The system of claim 44, wherein instructions for setting an XML template comprises instructions for:
selecting a XSLT template; and
selecting a server side scripting language.

46. The system of claim 31, wherein the program instructions further includes instructions for setting logging.

47. The system of claim 31, wherein the program instructions further includes instructions for setting access parameters.

48. The system of claim 47, wherein the instructions for setting access parameters includes instructions for:
including setting submittal methods;
setting submittal control location;
setting permissions; and
setting attributes.

49. The system of claim 48, wherein the program instructions further includes program instructions for adjusting properties with a settings manager.

50. The system of claim 49, wherein the program instructions for adjusting properties includes program instructions for
determining if the property is directed to a document library, a folder, or a document; and
setting properties, wherein the properties includes management dates, attributes, and sort types.

51. The system of claim 31, wherein the program instructions further includes program instructions for setting build parameters.

52. The system of claim 51, wherein the program instructions for setting the build parameters includes program instructions for determining at what time a build is performed.

53. The system of claim 31, wherein the program instructions further includes program instructions for accessing with a web submittal system.

54. The system of claim 53, wherein the web submittal system can edit properties of a folder, a document, or a document library.

55. The system of claim 53, wherein the web submittal system can delete a folder.

56. The system of claim 53, wherein the web submittal system can add or delete a document.

57. The system of claim 31, wherein the program instructions further includes instructions for searching with a web site searching.

58. The system of claim 57, wherein the web site searching can locate a document based on search parameters.

59. The system of claim 58, wherein the search parameters include publish dates and name.

60. The system of claim 58, wherein found documents can have properties edited or be deleted.

61. A web publishing system, comprising a removable medium storing programming instructions for
attaching a source folder to a document library;
attaching a destination web site location to a document library; and
building a web site for publication at the destination web site in accordance with the document library.

62. The system of claim 61, wherein the programming instructions for building the web site comprises programming instructions for
converting at least one document from the source folder to a PDF formatted document;
creating an XML file that includes the PDF formatted document; and
publishing the XML file on a web server corresponding to the destination web site.

63. The system of claim 61, wherein the program instructions further includes program instructions for setting properties associated with the document library.

64. The system of claim 63, wherein the properties includes management dates.

65. The system of claim 64, wherein the management dates are chosen from a set consisting of rolling, none, or discreet.

66. The system of claim 63, wherein the properties includes sort types.

67. The system of claim 66, wherein the sort types are chosen from a set consisting of ascending, descending, ascending date, descending date, or user defined.

68. The system of claim 63, wherein the properties includes attributes.

69. The system of claim 68, wherein attributes can be global or local.

70. The system of claim 68, wherein the attributes can apply to a document library, a folder, or a document.

71. The system of claim 61, wherein the program instructions further include instructions for setting filters.

72. The system of claim 61, wherein the program instructions further include instructions for setting searching properties.

73. The system of claim 72, wherein the searching properties include metatags.

74. The system of claim 61, wherein the program instructions further include instructions for setting an XML template.

75. The system of claim 74, wherein instructions for setting an XML template comprises instructions for:
selecting a XSLT template; and
selecting a server side scripting language.

76. The system of claim 61, wherein the program instructions further includes instructions for setting logging.

77. The system of claim 61, wherein the program instructions further includes instructions for setting access parameters.

78. The system of claim 77, wherein the instructions for setting access parameters includes instructions for:
including setting submittal methods;
setting submittal control location;
setting permissions; and
setting attributes.

79. The system of claim 78, wherein the program instructions further includes program instructions for adjusting properties with a settings manager.

80. The system of claim 79, wherein the program instructions for adjusting properties includes program instructions for
determining if the property is directed to a document library, a folder, or a document; and
setting properties, wherein the properties includes management dates, attributes, and sort types.

81. The system of claim 61, wherein the program instructions further includes program instructions for setting build parameters.

82. The system of claim 71, wherein the program instructions for setting the build parameters includes program instructions for determining at what time a build is performed.

83. The system of claim 61, wherein the program instructions further includes program instructions for accessing with a web submittal system.

84. The system of claim 83, wherein the web submittal system can edit properties of a folder, a document, or a document library.

85. The system of claim 83, wherein the web submittal system can delete a folder.

86. The system of claim 83, wherein the web submittal system can add or delete a document.

87. The system of claim 61, wherein the program instructions further includes instructions for searching with a web site searching.

88. The system of claim 87, wherein the web site searching can locate a document based on search parameters.

89. The system of claim 88, wherein the search parameters include publish dates and name.

90. The system of claim 88, wherein found documents can have properties edited or be deleted.

91. A web publishing system, comprising a computer storing software code that
sets parameters regarding one or more document libraries; and
builds a web site based on the document libraries and the parameters, wherein at least one document attached to the document libraries is converted to PDF format and published on the web site.

92. The web publishing system of claim 91, wherein the software code that set parameters includes software code that defines a document library and software code that sets build parameters.

93. The web publishing system of claim 92, wherein the software code that defines the document library includes code for
naming the document library;
attaching a source to the document library;
attaching a destination to the document library;
setting parameters regarding the document library; and
setting templates for the document library.

94. The web publishing system of claim 93, wherein the software code further includes code for setting filters for the document library.

95. The web publishing system of claim 93, wherein the software code further includes code for setting searching parameters for the document library.

96. The web publishing system of claim 93, wherein the software code further includes code for setting logging parameters for the document library.

97. The web publishing system of claim 93, wherein setting parameters for the document library includes setting management dates.

98. The web publishing system of claim 97, wherein the management dates can be set as discreet dates or as rolling dates.

99. The web publishing system of claim 93, wherein setting parameters for the document library includes setting sort types.

100. The web publishing system of claim 99, wherein the sort types includes ascending alphabetical, descending alphabetical, ascending by edit date, or descending by edit date.

101. The web publishing system of claim 100, wherein the sort types include a user defined sort type.

102. The web publishing system of claim 93, wherein setting parameters for the document library includes setting attributes.

103. The web publishing system of claim 92, wherein the software that sets parameters includes software that sets build parameters.

104. The web publishing system of claim 103, wherein the build parameters includes times to initiate a build process.

105. The web publishing system of claim 92, wherein the software that sets parameters includes a settings manager, the settings manager allowing a user to set parameters outside of the document definition software.

106. The web publishing system of claim 92, wherein the software code further includes a web submittal system.

107. The web publishing system of claim 106, wherein the software that sets parameters includes setting access parameters that defines access for users accessing through the web submittal system.

108. The web publishing system of claim 92, further including software that allows meta information searching.
